(19) United States
(12) Patent Application Publication
(10) Pub. No.: US 2023/0329273 A1
(43) Pub. Date: Oct. 19, 2023

(54) FLORAL WATER FROM COFFEE FLOWERS

(71) Applicant: SOCIETE DES PRODUITS NESTLE S.A., Vevey (CH)

(72) Inventors: VICTORIA BERRY-CAILLET, Monnaie (FR); JWANRO HUSSON, Lausanne 25 (CH); LILIAN BARRO, La ville Aux Dames (FR)

(21) Appl. No.: 18/044,654

(22) PCT Filed: Sep. 10, 2021
(86) PCT No.: PCT/EP2021/074922

§ 371 Date: Mar. 9, 2023

(30) Foreign Application Priority Data
Sep. 10, 2020 (EP) 20195528.3

(51) Int. Cl. A23L 27/10; A23F 5/50; A23G 3/48; A23L 33/105

(52) U.S. Cl. CPC A23F 5/505; A23G 3/48; A23L 27/115; A23L 33/105

(57) ABSTRACT

The present invention relates generally to the field of food. In particular, the present invention proposes a floral water. One embodiment of the present invention relates to a floral water from coffee flowers. The floral water is obtainable by a process comprising steam distillation of coffee flowers. For example, the floral water may be used as food flavoring ingredient. Some embodiments of the present invention relate to confectionary products flavored with floral water from coffee flowers.

The present invention relates generally to the field of food. In particular, the present invention proposes a floral water. One embodiment of the present invention relates to a floral water from coffee flowers. The floral water is obtainable by a process comprising steam distillation of coffee flowers. For example, the floral water may be used as food flavoring ingredient. Some embodiments of the present invention relate to confectionary products flavored with floral water from coffee flowers.

In the culinary world today, there is a trend to use as many parts as possible of a plant that is going to be used for the production of food.

Coffee consumption has a long tradition starting in the 15^{th} century where roasted coffee seeds were used for the preparation of a drink. Nowadays, maybe next to tea, coffee is one of the most consumed beverages in the world. The two most commonly grown coffee varieties are C. arabica and C. robusta. Today, coffee plants are cultivated globally in over 70 countries worldwide.

Despite the long tradition of coffee drinking and global coffee production and consumption, rarely other parts of the coffee plant than the seeds of the coffee plants have been used for food production. Only recently, in trying to make use of every part of the coffee tree, coffee flowers have been used to manufacture tea. Coffee flower-based tea offers a surprising wide taste variety, depending, e.g., on the coffee variety that is used for tea making.

Fresh coffee flowers have also been used for the decoration of food. However, fresh coffee flowers cannot be stored for extended periods of time.

Coffee flowers have an aroma that is often described to resemble jasmine or orange blossoms. The aroma of coffee flowers is perceived as very pleasant, so that recently perfumes with coffee flowers as ingredient have become available.

Teas made from coffee flowers have a pleasant aroma for immediate consumption, but often the aroma of coffee flower flavoured team is not strong enough that it can be used a flavouring ingredient for food, for example.

As fresh coffee flowers are difficult to preserve, it would be desirable to have available a coffee flower extract that is intense in flavor and aroma, is food grade and alcohol free and that is storage stable so that it can be used conveniently in the manufacturing of food products, for example.

Any reference to prior art documents in this specification is not to be considered an admission that such prior art is widely known or forms part of the common general knowledge in the field.

The objective of the present invention was it to enrich and/or improve the state of the art and, in particular, to provide the art with a food ingredient based on coffee flowers, that is storage stable and alcohol-free, conserves the flavor and aroma of coffee flavors and that can be used to effectively flavor foods or to at least provide a useful alternative to existing food ingredients.

The inventors were surprised to see that the objective of the present invention could be achieved by the subject matter of the independent claims. The dependent claims further develop the idea of the present invention.

Accordingly, the present invention provides a floral water from coffee flowers. The floral water from coffee flowers may be obtainable by a process comprising steam distillation of coffee flowers.

The present invention further provides the use of a floral water from coffee flowers as food flavouring agent.

As used in this specification, the words “comprises”, “comprising”, and similar words, are not to be interpreted in an exclusive or exhaustive sense. In other words, they are intended to mean “including, but not limited to”.

Consequently, the present invention relates in part to floral water from coffee flowers.

Coffee trees have delicate fragrant white flowers which can be perceived as reminiscent of jasmine flowers. The flowering seasons of C. robusta and C. arabica are quite different. Up to wo flowerings per year can occur for each species, and the flowering duration can spread over several weeks, if no synchronization is initiated.

Coffee plants that produce about 10 million tons of green coffee per year, can produce about 1.7 million tons of dry coffee flowers. The fresh coffee flowers yield can typically be around 6 to 10-fold higher than green coffee bean yield. As the dry matter content of fresh coffee flowers can be about 3%, the dried coffee flowers yield can be between 500 to 1000 kg/ha, depending on varieties and species.

Nowadays, some online distributors commercialize dried coffee flowers. The consumption of coffee flowers is not widespread. It is presently marketed to be consumed in the form of tea.

The present inventors have harvested coffee flowers on Coffea Arabica or Coffea Canephora trees just after flowering.

Floral water is the condensate water that remains after the extraction of a plant compound by distillation.

For the purpose of the present invention that plant compound comprises coffee flowers. For example, the plant compound may comprise at least 10 weight-%, at least 20 weight-%, at least 30 weight-%, at least 40 weight-%, at least 50 weight-%, at least 60 weight-%, at least 70 weight-%, at least 80 weight-%, at least 80 weight-%, or at least 95 weight-% coffee flowers. The plant compound may also essentially consist of coffee flowers.1 Advantageously, the higher the content of coffee flowers is in the plant compound, the purer the coffee flower taste and aroma of the resulting floral water will be.

Distillation may be vacuum distillation or steam distillation, for example. The inventors have found that the steam distillation of coffee flowers yields a condensate with a very intense coffee flower flavor and aroma.

Steam distillation is a separation process that is often used to isolate or enrich sensitive materials, such as aromatic compounds, temperature sensitive natural aromatic compounds, for example. Water or steam is added to the distillation device which allows heating and separating aromatic compounds from compositions at temperatures below their decomposition point.

The inventors have found that a very good floral water can be obtained if the coffee flowers are mixed with water before the steam is added. Without wishing to be bound by theory, the inventors believe that the added water protects the coffee flowers so that the sensitive aroma compounds can be gently extracted. For example, the coffee flowers may be mixed with water in a weight ratio of at least 1:200, at least about 1:150, at least about 1:100, or at least about 3:100, before steam distillation.

Steam distillation may be carried out at atmospheric pressure or under vacuum. Carrying out the steam distillation under atmospheric pressure has the advantage that no vacuum equipment needs to be used saving energy and equipment costs. The steam distillation may also be carried out under vacuum. This has the advantage that the steam distillation can be carried out at lower temperatures, which will protect any sensitive aroma compounds even more.

As the inventors have found no significant flavor differences for a floral water obtained by steam distillation at atmospheric pressure versus a floral water obtained by steam distillation under vacuum, the inventors propose to carry out the steam distillation at about atmospheric pressure at a temperature of about 100° C.

The unique flavor of the coffee flower is imparted to the floral water of the present invention by the aroma compounds of the coffee flower. The steam distillation allows it to achieve a surprisingly high concentration of these aroma compounds in the floral water. The volatile flavor constituents of the coffee flower are, for example described in the FLAVOUR AND FRAGRANCE JOURNAL, VOL. 12, 9-13 (1997). Accordingly, the coffee flower flavor compounds may be selected from the group consisting of benzaldehyde, methyl benzoate, phenylacetaldehyde, ethyl benzoate, phenylacetaldoxime methyl ether, benzyl acetate, methyl phenylacetate, methyl salicylate, benzyl alcohol, phenethyl alcohol, phenylacetonitrile, methyl N-methylanthranilate, 2-nitro-1-phenylethane, cinnamyl acetate, methyl anthranilate, indole, methyl N-formylanthranilate, or combinations thereof.

The floral water in accordance with the present invention may be obtained from any coffee flower. For example, the coffee flowers may be obtained from coffee plants selected from the group consisting of Coffea Arabica or Coffea Canephora or combinations thereof. As these are very frequently commercialized coffee plants, using flowers from these plants has the advantage that they are available in large amounts.

The coffee flowers may be used for the purpose of the present invention as fresh or as dried coffee flowers. Using fresh coffee flowers has the advantage that no drying process is necessary costs are saved and the aroma compounds can be extracted as completely as possible by steam distillation.

Drying the coffee flowers prior to steam distillation has the advantage that they can be easily transported to wherever the steam distillation equipment is located. Furthermore, dried coffee flowers are commercially available from specialist suppliers.

The floral water in accordance with the present invention may be used as aroma compound, as perfume or as food ingredient for example. The present inventors were surprised, in particular, how well the floral water of the present invention can be used as food flavoring ingredient.

Accordingly, the subject matter of the present invention also relates to the use of a floral water in accordance with the present invention as food flavouring agent. For the purpose of the present invention, the term “food” shall mean in accordance with Codes Alimentarius any substance, whether processed, semi-processed or raw, which is intended for human consumption, and includes drink, chewing gum and any substance which has been used in the manufacture, preparation or treatment of “food” but does not include cosmetics or tobacco or substances used only as drugs.

For example, the food that is to be flavored with the floral water in accordance with the present invention may be selected from the group consisting of water, water-based drinks, confectionery, milk-based products, milk alternatives, meal preparations, food powders to be dissolved in water or milk.

The inventors have prepared several different prototypes of food flavored with the floral water in accordance with the present invention. For example, they have prepared a flavored water by adding 1 weight-% of the floral water of the present invention to still or sparkling water. The present inventors have further prepared a fondant type of composition flavored with the floral water of the present invention that can, for example be used to prepare filled chocolates. To do this, the inventors have combined 75 ml water flavored with 5 weight-% floral water, 225 g sugar and 25 g glucose and have heated the mixture to about 114° C. the resulting fondant was used to fill chocolates. Remarkably, despite the heating to 114° C., a pleasant coffee flower flavor was achieved in the resulting chocolates.

This heat stability makes it possible that the floral water of the present invention can, for example, well be used in many confectionary products. For example, the confectionary may be bakers confectionery. The bakers confectionery may be selected from the group consisting of cakes, sweet pastries, doughnuts, scones, cookies, and biscuits.

The confectionery may also be sugar confectionery. The sugar confectionery may be selected from the group consisting of candies, chocolates, chewing gum, and ice cream.

The present inventors have carried out taste tests and have found that the floral water of the present invention must be used in the right quantities to ensure that the coffee flower aroma is perceived as noticeable and pleasant. A too low concentration will lead to a barely noticeable coffee flower flavor, while a too high concentration may lead to a taste that is perceived as too intense and artificial.

Accordingly, the present inventors propose that the floral water of the present invention is used in the food product in an amount in the range of about 0.1-10 weight %, of about 0.5-7 weight %, or of about 1-5 weight %.

Those skilled in the art will understand that they can freely combine all features of the present invention disclosed herein. In particular, features described for the product of the present invention may be combined with the use of the present invention and vice versa. Further, features described for different embodiments of the present invention may be combined.

Although the invention has been described by way of example, it should be appreciated that variations and modifications may be made without departing from the scope of the invention as defined in the claims.

Furthermore, where known equivalents exist to specific features, such equivalents are incorporated as if specifically referred in this specification. Further advantages and features of the present invention are apparent from the figures and non-limiting examples.

### EXAMPLES

### Example 1

### Floral Water From Coffee Flowers

15 g of dried coffee flowers are steamed for about 30 min, so as to recover 600 mL of distillate floral water. The flow rate is around 25 mL/min.

### Example 2

### Flavored Water From the Floral Water of Example 1

This floral water is used for example at 1% to flavor drinks such as still or sparkling water, homogenize for 1 minute.

### Example 3

### Chocolate Filling Using the Floral Water From Example 1

The aromatic water is incorporated in a “fondant” (5%), in order to create a confectionary filling like in an “AfterEight^{®}” type chocolate

1) In a saucepan, put 75 ml of water flavored with 5% floral water, then 225 g of sugar. Then add 25 g of glucose.

2) Bring this syrup to a boil and continue cooking until 114° C.

3) Immediately immerse the container in cold water to stop cooking.

4) Wait for the syrup to drop to 75° C., transfer it to the bowl of the robot equipped with the sheet and rotate at speed 6 until the mixture takes on the consistency of a white paste (16-17 min).

5) Melt 200 g dark chocolate in a bain-marie.

6) Spread the dark chocolate in a thin layer in a “Napolitain” mold then freeze chocolate at -20° C. for 10 min.

7) Fill them with a dab of fondant flavored with coffee flower floral water. Spread a second layer of melted chocolate to close the “Napolitain” mold.

8) Freeze 10 min at -20° C.

9) Unmold “ AfterEight^{®}” like chocolates.

1. Floral water from coffee flowers, obtainable by a process comprising a steam distillation of coffee flowers.

2. Floral water in accordance with claim 1, wherein the coffee flowers are mixed with water in a weight ratio of at least 1:200 before steam distillation.

3. Floral water in accordance with claim 1, wherein the steam distillation is carried out at about atmospheric pressure at a temperature of about 100° C.

4. Floral water in accordance with claim 1, wherein the coffee flowers are obtained from coffee plants selected from the group consisting of Coffea Arabica, Coffea Canephora and combinations thereof.

5. Floral water in accordance with claim 1, wherein the coffee flowers are used as fresh coffee flowers.

6. Floral water in accordance with claim 1, wherein the coffee flowers are used as dried coffee flowers.

7. A method for making a flavouring agent comprising using floral water from coffee flowers, obtainable by a process comprising a steam distillation of coffee flowers.

8. Method in accordance with claim 5, wherein the food is selected from the group consisting of water, water-based drinks, confectionery, milk-based products, milk alternatives, meal preparations, food powders to be dissolved in water and milk.

9. Method in accordance with claim 8, wherein the confectionary is bakers confectionery.

10. Method in accordance with claim 9, wherein the bakers confectionery is selected from the group consisting of cakes, sweet pastries, doughnuts, scones, cookies, and biscuits.

11. Method in accordance with claim 8, wherein the confectionery is sugar confectionery.

12. Method in accordance with claim 11, wherein the sugar confectionery is selected from the group consisting of candies, chocolates, chewing gum, and ice cream.

13. Method in accordance with claim 7, wherein the floral water is used in the food product in an amount in the range of about 0.1-10 weight %.
